(19) United States
(12) Patent Application Publication
(10) Pub. No.: US 2005/0132325 A1
(43) Pub. Date: Jun. 16, 2005

(54) Management of computer servers

(76) Inventor: Paul Unbehagen, Cary, NC (US)

Correspondence Address: WOMBLE CARLYLE SANDRIDGE & RICE, PLLC, P.O. BOX 7037, ATLANTA, GA, 30357-0037, US

(21) Appl. No.: 10/730,914

(22) Filed: Dec. 10, 2003

(51) Int. Cl. G06F 9/44

(52) U.S. Cl. 717/103

(57) ABSTRACT

A system for managing a plurality of managed servers that each execute a server agent includes a client computer having an interface for selecting a service to manage and one or more of the managed servers. The system further includes an agent manager coupled to the client computer. The agent manager requests a file from the selected managed servers that correspond to the first service, receives a modified file from the client computer and instructs the server agents that correspond to the selected managed servers to perform file modifications based on the modified file.

### FIELD OF THE INVENTION

One embodiment of the present invention is directed to computer servers. More particularly, one embodiment of the present invention is directed to the management of computer servers.

### BACKGROUND INFORMATION

Computer networks are exploding in use, due in part to the popularity of the Internet. The content of the Internet is typically stored on computer servers (“Web servers”) that store information, and serve the information to other computers on the Internet in response to a remote request. Computer servers on the Internet and other computer networks also are used for a myriad of other tasks that form the basic and advanced plumbing of any network. Examples of these tasks include Dynamic Host configuration (“DHCP”) for dynamic Internet Protocol (“IP”) address assignment, Dynamic Name Service (“DNS”) for domain name resolution to an IP address (e.g., “yahoo.com” to “203.3.42.2”), and E-mail functionality.

Each server in a network from time to time must be maintained or “managed”. For example, a new record might have to be added to a DNS server, or a record may have to be modified. Many of the servers that form the Internet operate under the Linux or UNIX operating systems. Services on a Linux or UNIX server are typically maintained by modifying configuration files that reside in the “/etc” directory of the server. Currently, when a change needs to be made to a particular service, such as DHCP or E-mail, one of the associated files, usually denoted with the extension of .conf, must be modified manually, on a per-server basis, with a text editor and then saved. Once the changes have been saved, the associated service must be restarted to cause the changes to take effect.

The known method of managing multiple configuration files for each service on every server requires a large amount of time and skill level. Care must be taken to ensure that the configuration is done properly or else the operator must go through a slow process of parsing the changes to find the flaw.

Based on the foregoing, there is a need for a improved system and method for managing computer servers that reduces the complexity and time required by known methods and systems.

### BRIEF DESCRIPTION OF THE DRAWINGS

FIG. 1 illustrates an example of a computer network that can implement one embodiment of the present invention.

FIG. 2 is a graphical view of an interface executed by a client computer of FIG. 1 in accordance with one embodiment of the present invention.

FIG. 3 illustrates an overview of the interaction between an interface of a client computer, an agent manager of a management server and each server agent of managed servers.

### DETAILED DESCRIPTION

One embodiment of the present invention is a computer server management system that allows multiple servers to be managed at the same time from a client computer having a graphical user interface (“GUI”). The result is an easy-to-use and intuitive interface for the management of multiple network services across multiple servers.

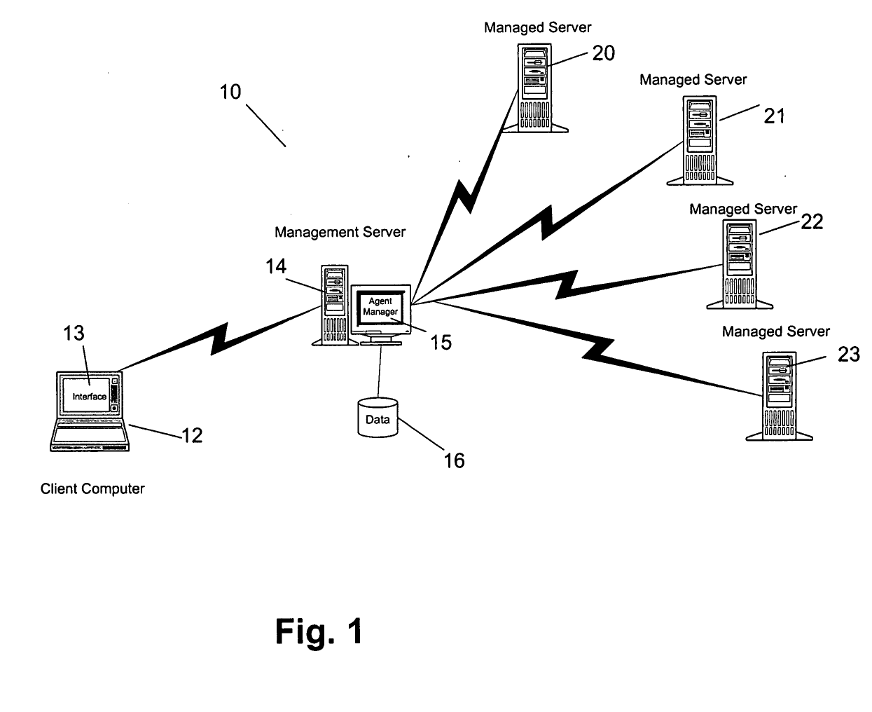

FIG. 1 illustrates an example of a computer network 10 that can implement one embodiment of the present invention. Network 10 includes a client computer 12, a management server computer 14, and managed server computers 20-23. All computers in network 10 are coupled together through communication links. The communication links may be local links, or may be remote links, such as communication links through the Internet.

One embodiment of client computer 12 executes a client application GUI or any other type of user interface 13 that allows managed tasks to be initiated. Client computer 12 can be any general purpose computer capable of executing software for implementing a GUI. The client application GUI is an intuitive, cross-platform application that allows secure remote access to the servers and services under management. Multiple client computers can allow multiple users to manage the remote servers on network 10.

Managed servers 20-23 are general purpose computer servers that in one embodiment execute Internet Web services. In one embodiment, one or more of managed servers 20-23 execute the Linux or UNIX operating system. Embodiments of managed servers 20-23 also each execute a server agent. In one embodiment, the server agent is a software program that resides on each managed servers 20-23 as a server daemon with its own user account with administrator privileges in order to manage each of the network services on the particular server.

One embodiment of management server 14 is a general purpose computer server that executes an agent manager 15. Agent manager 15 is responsible for communication between interface 13 on client computer 12 and the server agents on managed servers 20-23. Management server 14 is coupled to a management database 16. One embodiment of management database 16 stores all current configurations of managed servers 20-23 and a select amount of previous configurations for reference purposes.

Agent manager 15 of management server 14 provides the method of communication between the individual server agents on managed servers 20-23 under management and interface 13 on client computer 12, while maintaining management database 16 with the most current information and archiving any older information for rollback needs.

Management database 16 is the central location where all necessary configuration information is stored and referenced by both managed servers 20-23 and the client interfaces. The communication between each client interface is controlled through agent manager 15. Management database 16 store *.conf files of each service on a per server basis and maintains backup copies of old configurations for roll back purposes. Management database 16 further maintains per server configuration information for both the client interface and the managed server agent.

One embodiment of management database 16 maintains several tables that allows management server 14 to keep track of multiple variables necessary to maintain a network of servers and services securely. Some of these tables may include a user table to provide for authentication separate from the server user/password files so that permissions to services can be passed in the authentication messages more easily. This separation of authentication into the database also simplifies the management of user accounts while providing for full resiliency if a network or system failure occurs. In one embodiment, this resiliency is attainable as long as the database is frequently backed up or replicated.

Each embodiment of the agent on each managed server 20-23 is responsible for the local management of the individual server on which it resides. It makes all necessary changes to the individual configuration files that reside in the directory for each network service application. The configuration files are typically located in the /etc directory or some subdirectory within the /etc directory in one embodiment. In other embodiments, the configuration files are stored in another directory.

In another embodiment of network 10, the functionality of agent manager 15 and database 16 is implemented on client computer 12, and management server 14 is eliminated. This “client-only” embodiment can be used when a small number (e.g., 10 or less) of servers are being managed. In contrast, the “client/server” model illustrated in FIG. 1 can be used to manage a larger number (e.g., 50-75) of servers and services at once.

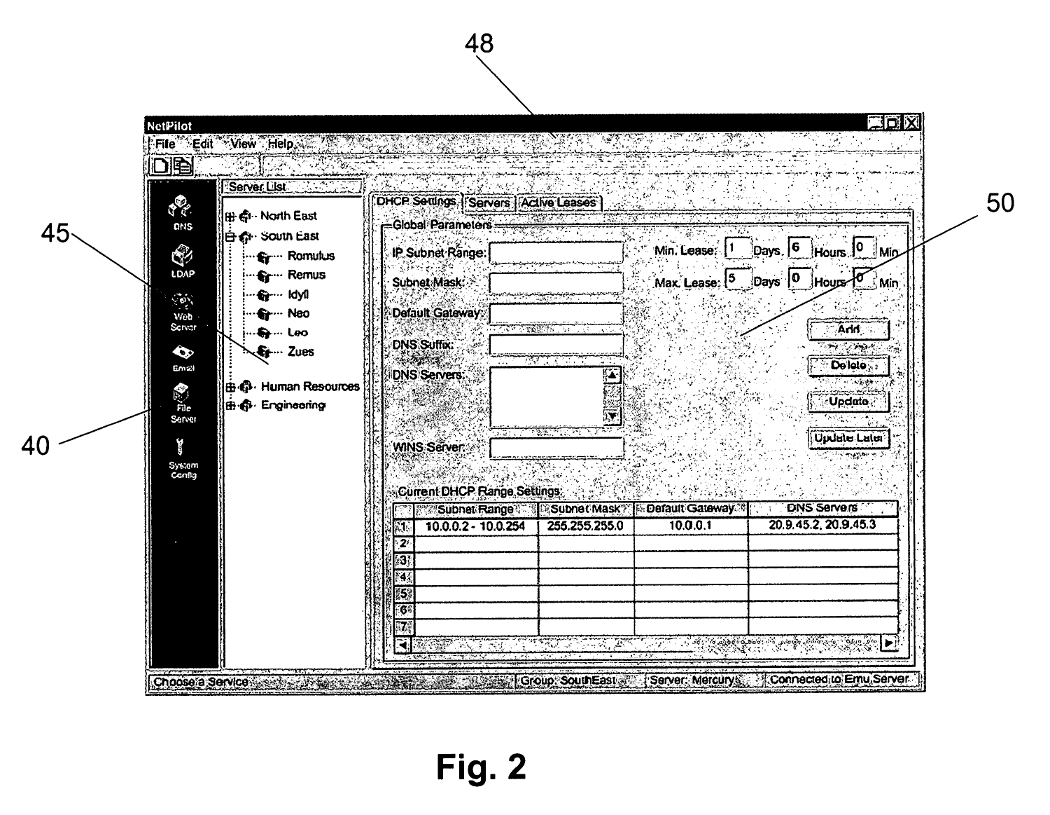

FIG. 2 is a graphical view of an interface 48 executed by client computer 12 of FIG. 1 in accordance with one embodiment of the present invention. In one embodiment, interface 48 resides on the respective client computer of each individual user that is managing managed servers 20-23. In one embodiment, interface 48 is a GUI and is split into different panes or bars 40 and 45 in a column view. Each bar is responsible for providing an easy-to-use application by separating the larger management tasks into smaller distinct categories based on server application, server name, or server group. For each client computer running interface 48, an Extensible Markup Language (“XML”) file may be stored locally containing the last known list of servers and services that are being managed.

Interface 48 includes a management service bar 40 where the individual services that need to be managed are chosen. Each service that can be managed may be displayed as a separate icon. Access to these services are allowed during the authentication process during login. This is to allow the capability of assigning the management responsibility of certain services to different users. For example, different groups in an organization may be responsible for the management of Web services such as HyperText Transfer Protocol (“HTTP”) and DNS, while others could be responsible for the management of end-user services such as Dynamic Host Configuration Protocol (“DHCP”), File Transfer Protocol (“FTP”), Samba, Lightweight Directory Access Protocol (“LDAP”), and E-mail.

Once a service is chosen from the first column, or management service bar 40, a list of servers currently under management on the client application will appear in a server list bar 45. This allows the end-user to see only the servers they are responsible for in server list bar 45.

Server list bar 45 provides a list of servers that are configured to run the service selected from management service bar 40. Servers can be grouped together in several ways. For example, servers can be grouped by organization (e.g., Finance), or by geographic region (e.g., Southeast U.S.).

Servers may need to be added for each service. To ease the addition and deletion of servers on a per service basis, servers that need to be managed can be added to interface 48 globally under a managed servers component that may appear in the management service bar 40. By adding the individual servers globally, the servers can be added individually under each service more easily. During the addition of any new server, multiple options may be provisioned. Examples of options include Server Type, Host name, IP Address, DNS name, system hardware configuration auto discovery, notes regarding an individual server, etc.

Interface 48 further includes a menu 50 that allows information to be entered in order to execute the desired management task. Menu 50 will vary depending on which service is selected and which server or servers are selected. Menu 50 includes tabs for viewing additional information.

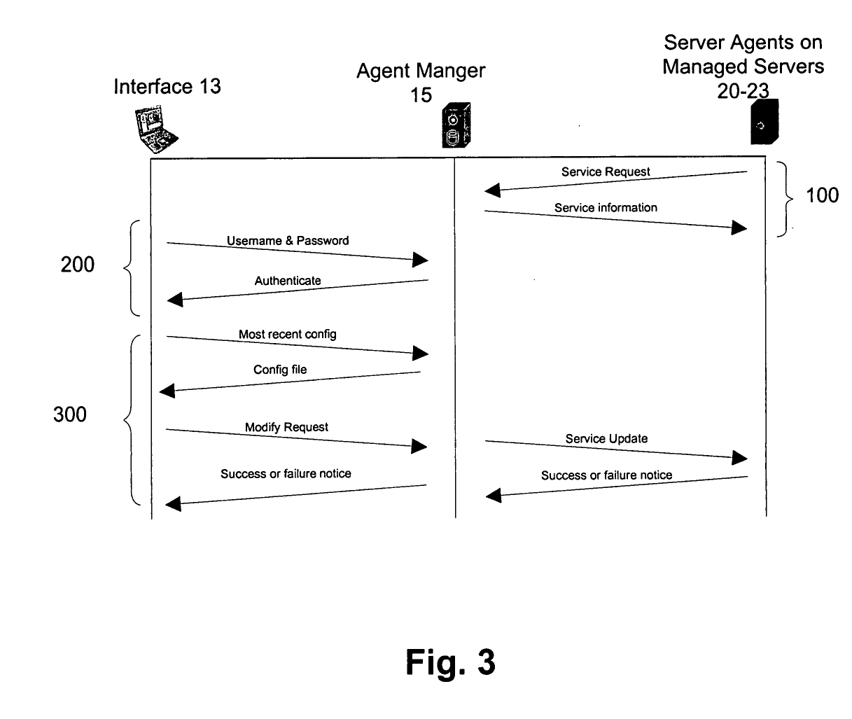

FIG. 3 illustrates an overview of the interaction between interface 13 of client computer 12, agent manager 15 of management server 14 and each server agent of managed servers 20-23. The interaction shown in FIG. 3 provides an example of a management change from login to first change, and includes interactions 100, 200 and 300.

Interactions 100: Upon instantiation of the server agent on the managed server, either due a new install or system reboot, the agent will make a service request of agent manager 15 to verify what services are configured for the server it is managing. In addition, the server agent will check if there are any recent changes.

Interactions 200: In order to verify the user's credentials and permissions, each user is required to login to agent manager 15 in one embodiment. This provides the additional benefit of ensuring that the user is authenticated to manage a given service. In one embodiment, each user will be set up by the administrator account with permissions to the services they are responsible for before they may login and use the interface 13.

Interactions 300: When a service needs to be added or modified, interface 13 will send a request (“Most recent config”) for the current *.conf file for that service on the respective server which is then requested from agent manager 15. Upon reception of the file (“Config file”) any changes to the service are applied to the *.conf file (“Modify Request”) and sent back to agent manager 15 for replication to the server agents (“Service update”). In one embodiment, agent manager 15 communicates the changes to the server agents using simple messaging, informing the server agents of any modifications needed for a particular service application. A success or failure notice is then sent by the server agents to agent manager 15, and then to interface 13.

As described, the server management system in accordance with embodiments of the present invention allows network administrators and other users to manage multiple servers and multiple services across a network or within a single data center. The matrix design of the client interface gives the user the ability to manage multiple services that exist on multiple servers at one time.

Embodiments of the invention can be deployed to address a broader market due flexible scaling and cost structure. In addition, managed server agent software can be installed onto network servers with little or no service disruption. Embodiments are implemented so that the agent software operates as a user on the managed systems, allowing for security through a self contained environment on each server being managed.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A system for managing a plurality of managed servers, wherein each managed server executes a server agent, said system comprising:
a client computer having an interface for selecting a first service and one or more of the managed servers; and
an agent manager coupled to said client computer for requesting a first file from said selected managed servers that correspond to the first service, and for receiving a modified first file from said client computer and instructing first server agents that correspond to the selected managed servers to perform file modifications based on the modified first file.

2. The system of claim 1, further comprising a management database coupled to said agent manager for storing configuration information of the plurality of managed servers.

3. The system of claim 1, where said agent manager is executed on a management computer.

4. The system of claim 1, where said agent manager is executed on said client computer.

5. The system of claim 1, wherein said interface displays a first set of managed servers that are configured to run said first service in response to said selection of said first service.

6. The system of claim 1, wherein the plurality of managed servers execute a Linux operating system.

7. The system of claim 1, wherein the plurality of managed servers execute a UNIX operating system.

8. The system of claim 5, wherein said displayed first set of managed servers are grouped based on a first parameter.

9. The system of claim 1, wherein said agent manager instructs said first server agents using messaging.

10. The system of claim 1, wherein the modified first file is a modified configuration file corresponding to the first service.

11. A method of managing a first plurality of servers, said method comprising:
receiving a selection of a service to manage;
in response to said selection, displaying a second plurality of servers that are configured to run the service;
receiving a management task; and
initiating a revision of a file in at least one of the second plurality of servers to implement the management task.

12. The method of claim 11, further comprising:
receiving a selection of the at least one of the second plurality of servers.

13. The method of claim 11, further comprising:
displaying a graphical user interface that displays a plurality of services and the second plurality of servers.

14. The method of claim 11, wherein said initiating the revision comprises messaging a modification of the file to server agents corresponding to the second plurality of servers.

15. The method of claim 11, wherein the first plurality of managed servers execute a Linux operating system.

16. The method of claim 11, wherein the first plurality of managed servers execute a UNIX operating system.

17. The system of claim 11, wherein said displayed second plurality of servers are grouped based on a first parameter.

18. The method of claim 11, further comprising:
receiving an indication of success of the modification of the file from the server agents.

19. A method of managing a plurality of managed servers, wherein each of said servers executes a server agent, said method comprising:
receiving a selection of a service and at least one of the plurality of managed servers;
receiving a configuration file of the service from each of the selected plurality of managed servers; and
initiating changes to the configuration file on the selected plurality of managed servers by the server agents.

20. The method of claim 19, further comprising:
displaying on a graphical user interface a list of managed services and corresponding managed servers.

21. The method of claim 19, wherein said initiating changes comprises messaging a modification of the configuration file to the server agents.

22. The method of claim 19, further comprising:
receiving an indication of success of the changes from the server agents.
